(19) United States
(12) Patent Application Publication
(10) Pub. No.: US 2013/0112718 A1
(43) Pub. Date: May 9, 2013

(54) Cartridge Closure and Method

(71) Applicant: Keith F. Roberts, Rockport, MA (US)

(72) Inventor: Keith F. Roberts, Rockport, MA (US)

(21) Appl. No.: 13/292,758

(22) Filed: Nov. 9, 2011

(51) Int. Cl. B67D 7/06

(52) U.S. Cl. 222/544; 29/428

(57) ABSTRACT

A prepackaged closure for temporarily closing and sealing the nozzle of a dispenser cartridge includes a mass of tacky, finger-moldable sealant impermeable to volatile compounds that facilitate the fluency of the material contained in the cartridge. The mass, preferably butyl rubber, is contained in a protective package formed from separable components, the mass and container being proportioned to facilitate removal of the mass from the container. Upon removal from the container, the mass is applied and finger-molded to and about the tip of the nozzle to effect the seal.

### FIELD OF THE INVENTION

This invention relates to a sealing device for temporarily sealing the nozzle of a dispensing cartridge, particularly a cartridge in which its contents have been only partially dispensed.

### BACKGROUND OF THE INVENTION

Fluent materials as are used in the building and other trades typically are provided in a convenient cylindrical cartridge having a nozzle at its forward end and a piston driven from the rear by a dispensing mechanism that operates the cartridge. Such materials may include, for example, caulking, sealants, adhesives and the like. The cartridge is provided with a nozzle having a closed tip to seal the contents of the cartridge from the environment. Typically the nozzle is formed from plastic and its tip is cut off to form an outlet orifice at the end of the nozzle through which the contents may be dispensed. If, after use, some fluent material remains in the cartridge the outlet orifice must be resealed in order to prevent the unused material from being exposed to the atmosphere and drying out. Even if a small container of the material that remains in the nozzle hardens that will be sufficient to obstruct the nozzle which typically has a tapered passageway, rendering the remaining contents unusable.

While a number of devices for closing the nozzle of such cartridges have been provided or proposed in the prior art, there still is a need for a closure that maintains an effective seal for extended periods of time, that is simple and easy to use and does not depend on mechanical fitting and locking a cover to the tip of the nozzle The present invention is directed to such an improved, simplified, pre-packaged closure for sealing the nozzle of a partially used cartridge.

### SUMMARY OF THE INVENTION

The nozzle seal of the present invention comprises a manually moldable, shapeable mass of a highly tacky material that also is impermeable to air, moisture and solvents that may be a component of the material contained in the cartridge. The mass is sufficient in size to enable it to be applied to the outlet orifice of the nozzle and be finger-molded to and rearwardly about the outer surface of the surface of the nozzle. The container of the mass that covers the outlet orifice of the nozzle assures the integrity of the seal to prevent the material in the cartridge from drying out. The highly tacky nature of the mass assures that it will remain secured to the nozzle in intimate, sealed contact with the nozzle surface. It is reusable.

In another aspect of the invention, the sealing mass is packaged within a container and in a manner that facilitates removal of the mass from the container. The tackiness of the mass causes it to adhere to the interior of the package. In order to facilitate manual removal from the package the container is formed to include two separable parts, separable along a parting line. The dimensions of the container are selected with respect to the size of the mass so that when the mass is contained in one of the parts of the container a container of the mass will protrude outwardly beyond the parting line. The outwardly protruding container provides a finger-engageable container that can be gripped to separate the mass from the container of the container to which it is attached.

### DRAWINGS

The various aspects of the invention will be appreciated more fully from the following description, with reference to the accompanying drawings in which:

FIG. 1 is a diagrammatic side view of the forward end of a dispensing cartridge and its nozzle;

FIG. 2 is a diagrammatic side view of an exemplary embodiment of the package that includes the sealant mass and its container;

FIG. 3 is a diagrammatic side view of the package of FIG. 2 with a section of the container removed to expose the sealant mass;

FIG. 4 is a plan view of the package of FIG. 3 as seen along the line 4-4 of FIG. 3; and

FIG. 5 is a diagrammatic illustration of a cartridge nozzle with the sealing mass in two stages of its application to seal the outlet orifice of the nozzle.

### DESCRIPTION OF AN ILLUSTRATIVE EMBODIMENT

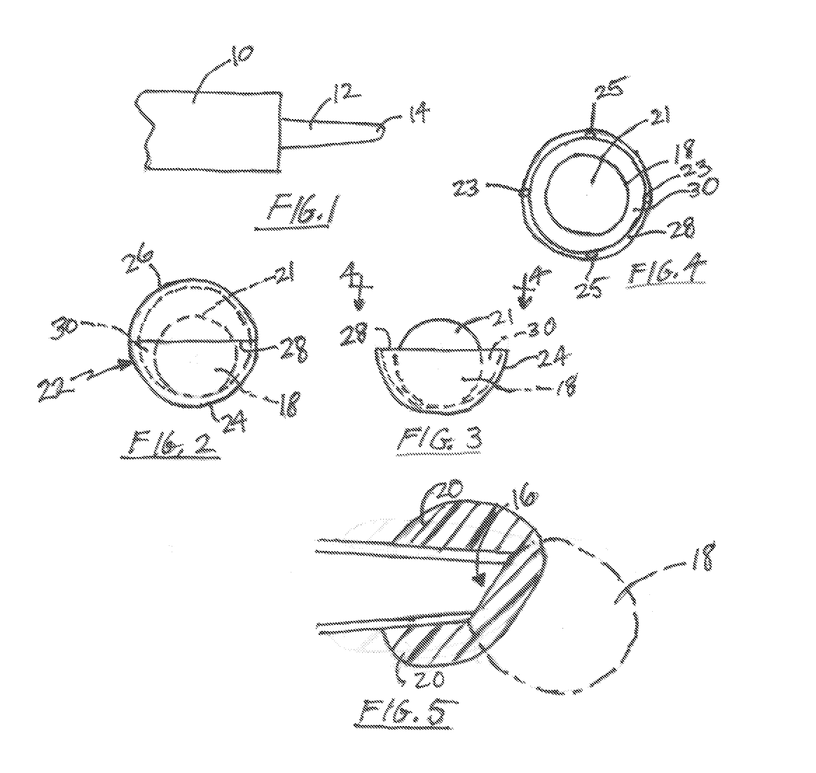

FIG. 1 shows the forward end of a typical cartridge including a cylinder 10 containing the material to be dispensed and a forwardly extending nozzle 12 attached to the forward end of the cylinder 10. The material to be dispensed may be any of a variety of fluent materials capable of being forced out of the cylinder 10 through the nozzle 12. such as caulking, sealants, adhesives and the like. The nozzle 12 typically is tapered and is formed from plastic with its forward end closed. The tip 14 must be cut to define an outlet orifice 16 through which the material is dispensed. When only a container 22 of the contents of the cartridge is used and it is desired to preserve the remaining contents for future use the orifice 16 must be fully closed and sealed to prevent any component of the material by which it maintains its fluency, such as moisture, solvents, lubricants or the like volatiles to escape.

I have found that a simple, inexpensive and effective seal may be formed by gently applying a highly tacky, moldable and finger-shapeable mass 18, preferably of butyl rubber, to the outlet orifice 16 of the nozzle 12 to cover the orifice 16 and then kneading with one's fingers other portions 20 of the mass 18 about the external surface of the nozzle 12 rearwardly of the orifice 16. The degree of tackiness of the material should be such as to insure full intimate contact of the mass 18 with outer surface of the nozzle 12 to form a seal fully about and along the exterior of the nozzle 12 as well as to assure that the mass 18 will remain securely attached to the nozzle 12 surface for extended times. It is not necessary to force any of the mass 18 into the passageway of the nozzle 12 to effect the seal.

FIG. 5 illustrates the application of a mass 18 of sealing material to the cartridge nozzle 12 in accordance with the invention. The mass 18 may be in the form of a ball that is applied to the tip of the nozzle 12 to cover the outlet orifice 16 that was formed when the tip of the nozzle 12 was cut off. The highly tacky nature of the mass 18 will cause it to detachably adhere to the tip as shown in phantom in FIG. 5. The mass 18 then is shaped and molded by one's fingers to cause the mass 18 to surround and intimately contact the external surface of the nozzle 12 as shown in solid in FIG. 4. The trailing portion 20 of the mass 18 is pressed firmly against the nozzle 12 to assure that its tackiness will form an intimate but releasable bond. I have found that butyl rubber appears to be an ideal material for this purpose, although other materials having the requisite characteristics might be employed. An additional characteristic of butyl rubber that makes it particularly effective for use in the invention is that it relatively non-viscous, that is, it will not tend to deform under the influence of gravity from the shape in which it is molded to the nozzle 12. Thus, the seal can be expected to remain effective for extended time periods.

FIGS. 2-4 illustrate an exemplary package for the sealing mass 18. Because the tackiness of the sealant causes it to adhere, detachably, to the interior of its container, the container 22 and mass 18 are cooperatively configured to facilitate manual removal of the mass 18 from the container. To that end, the container 22 is openable into two components 24, 26, such as the hemispheres shown in the drawings, having a parting line 28 where the components are separably joined. Preferably, the components 24, 26 are reconnectable to enable the sealant mass 18 to be replaced in the container after it has been used so that it can be used again. For example the mating edges of the container parts may be formed with cooperative pins 23 and sockets 25. The dimensions of the sealant mass 18 and container are selected so that when the container is opened a portion 21 of the mass 18 will protrude outwardly beyond the parting line 28 as suggested in FIG. 3. The protruding portion 21 of the sealing mass 18 facilitates engagement with the user's finger to detach and remove the mass 18 from the container. By way of example the container preferably may be spherical and the mass 18 may be formed in a somewhat ball shape with the diameter of the ball being greater than the radius of the spherical container. Thus, when the container is opened the mass 18 will protrude outwardly beyond the parting line 28 and may be easily removed. Additionally, the smaller size of the mass 18 leaves space 30 between it and the inner surface of the container to enable the user to better engage the mass 18 with a finger. By way of further example, a spherical container having a diameter of about one inch may accommodate a ball of sealant with a diameter of about ⅝ inch, resulting in a protrusion beyond the parting line 28 of about ⅛ inch. Additionally, I have found that a ball of sealant of at least about ⅝ inch diameter provides enough sealant to seal the tip of most conventional cartridge nozzles. It should be understood, however, that other embodiments of the invention having other container shapes as well as other shapes for the sealant mass 18 may be employed.

Thus, the invention provides a simple, convenient and inexpensive approach to preserving partially used dispensing cartridges in readiness for subsequent use. The rigid, reclosable container protects the sealant from dust and dirt and may be carried or stored anywhere such as in a toolbox, tool belt or in one's pocket. The sealant mass 18, particularly when formed from butyl rubber, can be reused repeatedly as long as it is protected from dirt and dust, as by the container. Although its high tackiness maintains an effective intimate seal against the nozzle surface, it leaves no residue when detached.

It should be understood, however, that the foregoing description of the invention is intended merely to be illustrative and that other embodiments, modifications and equivalents embodying the principles of the invention may be apparent to those skilled in the art.

I claim:

1. A packaged closure for sealing the outlet orifice of the nozzle of a cartridge containing a fluent material dispensable through the nozzle comprising:
a mass of tacky, finger-moldable sealant that is impermeable to air, moisture and volatile compounds that facilitate the fluency of the material in the cartridge;
a container for the sealant mass, the container having components that are openable along a parting line to expose the sealant mass contained in the container, the sealant mass being detachably adhered, by its tackiness, to one of the container components, the relative sizes and shapes of the sealant mass and the component to which it is attached being such that the mass protrudes outwardly beyond the parting line of that container component.

2. The article as defined in claim 1 wherein the sealant mass comprises butyl rubber.

3. The article as defined in claim 1 wherein the container is rigid.

4. The article as defined in claim 1 wherein the container is transparent and the sealant mass is visible within the container.

5. The article as defined in claim I wherein the sealant mass is spaced from the parting line of the container component to which it is attached, thereby to facilitate separation of the mass from the container component with one's finger.

6. The article as defined in claim 1 further comprising:
the container being spherical and defined by hemispherical components;
the sealant mass being attached to one of the hemispherical components and having a radially extending dimension that is greater than the inner radius of the spherical container.

7. The article as defined in claim 5 wherein the sealant mass is generally ball-shaped and has a diameter greater than the inner radius of the container.

8. A method of sealing the outlet orifice of a nozzle of a dispensing cartridge containing a fluent material dispensable through the nozzle comprising:
providing a mass of tacky, finger-moldable sealant that is impermeable to air, moisture and volatile compounds that facilitate the fluency of the material in the cartridge,
applying the mass to the tip of the nozzle to close the orifice and effect a seal about the nozzle tip that defines the orifice;
manually shaping portions of the sealant mass to and about the nozzle rearwardly of the orifice and pressing those portions against the external surface of the nozzle to surround the nozzle and effect an intimate seal to and about the nozzle.

9. The method as defined in claim 8 wherein the degree of tackiness of the mass enables it to be manually detached from the nozzle.

10. The method as defined in claim 9 wherein the sealant comprises butyl rubber.
